(19) United States
(12) Patent Application Publication
(10) Pub. No.: US 2005/0044531 A1
(43) Pub. Date: Feb. 24, 2005

(54) Methods and systems for deploying computer source code

(75) Inventors: Rajesh Baldev Chawla, Olathe, KS (US); Dustin E. Yates, Olathe, KS (US); Pavel Vladimirovich Vlasov, Lenexa, KS (US)

Correspondence Address: John S. Beulick;ARMSTRONG TEASDALE LLP, Suite 2600, One Metropolitan Square, St. Louis, MO, 63102, US

(73) Assignee: ERC-IP, LLC

(21) Appl. No.: 10/956,967

(22) Filed: Oct. 1, 2004

Related U.S. Application Data
(63) Continuation-in-part of application No. 10/457,580, filed on Jun. 9, 2003.

(51) Int. Cl. G06F 9/44

(52) U.S. Cl. 717/122; 717/172; 717/120

(57) ABSTRACT

A method for deploying source code from a version control system to at least one of a web server and an application server is provided. The method uses a build environment configured to be coupled to a client utility and a version control repository. The method includes scheduling a build request using a build scheduler, prompting a deployer to invoke the client utility including designating a specific time for execution, extracting source code at the scheduled time from the version control repository using the build environment, verifying promotion groups, building compiled modules to form an application, and deploying the application to at least one of a web server and an application server.

### CROSS REFERENCE TO RELATED APPLICATIONS

This application is a continuation-in-part of U.S. patent application Ser. No. 10/457,580, filed Jun. 9, 2003, entitled “Methods and Systems for Deploying Computer Source Code,” which is incorporated by reference herein in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to deploying computer source code and, more particularly, to network-based methods and systems for deploying computer source code to selected web and application servers.

Software applications are commonly developed under a collaborative effort by multiple software developers operating within a client/server computing network. A software application is generally represented by one or more project files. Such files may, for example, comprise web pages which contain hypertext markup language (HTML). These files may link to other files within that same project. For example, linked files may represent web pages that are hyperlinked to the web page for the original project file.

The client/server computing environment allows multiple developers to share these project files and collectively work on and develop an application project. In such a computing environment, the software application (represented by one or more project files under development) is generally stored on the server and is accessed and modified by one or more developers residing at the client computers. A developer at the client computer may work on the software project by creating new files or editing existing files on the server. To edit an existing file, the developer typically obtains a copy of the project file from the server. When a new file is created or an existing file is edited, the developer eventually saves the file directly on the server. In the case where the file is linked to other files, the file is processed to identify any of these linked files which require corresponding modifications. The identified linked files are then also modified in accordance with the changes in the original file. These new or edited files are thereafter made available on the server for further potential development.

Business entities and other organizations oftentimes require such software development. These entities may, for example, require multiple concurrent software projects. These projects may be for a short duration (e.g., 60-90 days), use a small predefined set of technologies, and/or require frequent code moves. These entities may also deploy these software projects to multiple servers, and may have at least one server hosting multiple projects.

In these situations, business entities and other organizations may experience difficulties communicating the organization's coding and infrastructure guidelines to project teams when developing software. The business entities may also experience an increased probability of error from manual deployment of source code, conflicts between operations teams and project teams, and increased probability of error from different teams deploying source code to a staging server and a production server. In addition, changes in a computer system infrastructure may preclude the use of already existing source code. Moreover, pre-deploy and post-deploy validations may not, in some situations, be implemented in a manual deployment process.

### BRIEF DESCRIPTION OF THE INVENTION

In one aspect, a method for deploying source code from a version control system to at least one of a web server and an application server is provided. The method uses a build environment configured to be coupled to a client utility and a version control repository. The method includes scheduling a build request using a build scheduler, prompting a deployer to invoke the client utility including designating a specific time for execution, extracting source code at the scheduled time from the version control repository using the build environment, verifying promotion groups, building compiled modules to form an application, and deploying the application to at least one of a web server and an application server.

In another aspect, a network based system for deploying source code from a version control system to at least one of a web server and an application server is provided. The system includes a build scheduler configured to prompt a deployer to designate a specific time to execute a build request. The system also includes a version control repository, a client utility, and a build environment. The build environment is configured to be coupled to the client utility and the version control repository. The build environment includes at least one of a development environment, a staging environment, a production environment, and a plurality of extractor servers for hosting a plurality of extractors. The build environment is configured to extract source code at the scheduled time from the version control repository, verify promotion groups, build compiled modules to form an application; and deploy the application to at least one of a web server and an application server.

In another aspect, a computer program embodied on a computer readable medium for deploying source code from a version control system to at least one of a web server and an application server is provided. The program includes at least one code segment that prompts a deployer to designate a specific time to execute a build request using a build scheduler, prompts a deployer to invoke a client utility, and extracts source code at the scheduled time from the version control repository using a build environment. The build environment is configured to be coupled to the client utility and the version control repository. The program also includes at least one code segment that verifies promotion groups, builds compiled modules to form an application, and deploys the application to at least one of a web server and an application server.

### BRIEF DESCRIPTION OF THE DRAWINGS

FIG. 1 is a flowchart illustrating an example prior art process of deploying source code.

FIG. 2 is a simplified block diagram of an E-Builder System (EBS) in accordance with one embodiment of the present invention.

FIGS. 3A and 3B show an expanded version block diagram of an example embodiment of a server farm included in EBS.

FIG. 4 is a flowchart illustrating example processes utilized by EBS.

FIG. 5 is a system diagram of an E-Builder System (EBS) in accordance with one embodiment of the present invention.

FIG. 6 is a deployment diagram illustrating an example embodiment of EBS.

FIG. 7 is a flowchart illustrating example development processes utilized by EBS.

FIG. 8 is a flowchart illustrating example build processes utilized by EBS.

FIG. 9 is a block diagram illustrating an example embodiment of a hierarchy of build sets and a property/build script resolution process for EBS.

FIG. 10 is an example embodiment of a user interface displaying a change report included within an EBS.

FIG. 11 is an example embodiment of a user interface displaying a root cause analysis report included within an EBS.

### DETAILED DESCRIPTION OF THE INVENTION

Example embodiments of systems and processes that facilitate deployment of computer source code from a version control system to at least one of a web and application server through the use of an E-Builder System (EBS) are described below in detail. A technical effect of the systems and processes described herein include at least one of an automatic deployment of computer source code from a version control system, known as a PVCS Version Manager, to a development, a staging, and a production environment for building, compiling, packaging, and deploying files to a specific web or application server. (PVCS Version Manager is manufactured by Merant® International Limited Corporation, Newbury Berkshire, United Kingdom.)

The systems and processes described herein also include functionality that facilitates the automatic deployment of computer source code from the version control system to a web or application server. More specifically, the systems and processes include at least one of a build limit, a build scheduler, a build agent monitor, a filtering system, and a root cause analysis module. The build limit functionality prevents a deployer or a developer from creating more build requests per day than specified in a build limit parameter. The build scheduler allows a user to schedule one time, recurring or advanced recurring builds.

The build agent monitor function is invoked by the scheduler to connect to each builder on a predetermined schedule to determine whether the builder is running and responding. If, for example, the builder does not respond to a predetermined number of broadcasts from the monitor, an e-mail notification is transmitted to an administrator. The filtering system protects sensitive information (e.g., production database passwords) by not allowing developers to have access to it. This sensitive information is therefore not stored in the version control system. The root cause analysis module analyzes failed builds, summarizes the most common causes of failures, and then creates a document that maps build script name and line number to a failure cause and recovery instructions.

In the example embodiment, the EBS includes two build servers and a client utility. The EBS retrieves archived source code from the PVCS Version Manager, performs a number of validations to determine whether the code is correct, and then deploys the code. A deployer, a person invoking the client utility, needs to only select a logical product/component/node names (e.g., ERCClaims/Web) from a list of products available for deployment and input a version label. As described herein, the term deployer includes a developer. The remaining parameters are stored in the EBS database. The configuration files are stored in the PVCS Version Manager and are automatically provided by the EBS at startup.

For purposes of this patent application, a software development project delivers a product that functions in the context of an infrastructure. Infrastructure is a set of software technologies running on physical nodes (also known as boxes). A product includes multiple components (e.g., jsp page, database table) organized into subsystems (e.g., web application and Oracle® database). (Oracle is a registered trademark of Oracle Corporation, Redwood City, Calif.) A subsystem is part of a product that represents particular technology and is deployed on a particular box. In the PVCS Version Manager, products are represented by repositories and subsystems are represented by subproducts. A build process with EBS is a process of deployment of a subsystem from PVCS Version Manager subproject to a box. A builder node is a definition of deployment of a subsystem to a box.

In the example embodiment, EBS includes a build server, an environment version control repository, and a project definition files version control repository. The build server operates as a foreground process, a background process on Unix® OS, or as a service on Windows® NT/2000/XP. (Unix is a registered trademark of American Telephone and Telegraph Company Corporation, New York, N.Y.; and Windows is a registered trademark of Microsoft Corporation, Redmond, Wash.). The environment version control repository includes build scripts, properties, and other technology-specific files. The EBS database holds configuration parameters for products, components and other EBS objects.

The EBS enables a business entity to separate development and deployment processes in all environments; standardize build processes based on technology used and parameterize these processes based on at least one of component, environment, and server; version control build files; create an isolated build environment; add pre-validation and post-validation steps to the build process; and enforce adherence with infrastructure and architectural guidelines by incorporating them into the build process.

In one embodiment, the EBS is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

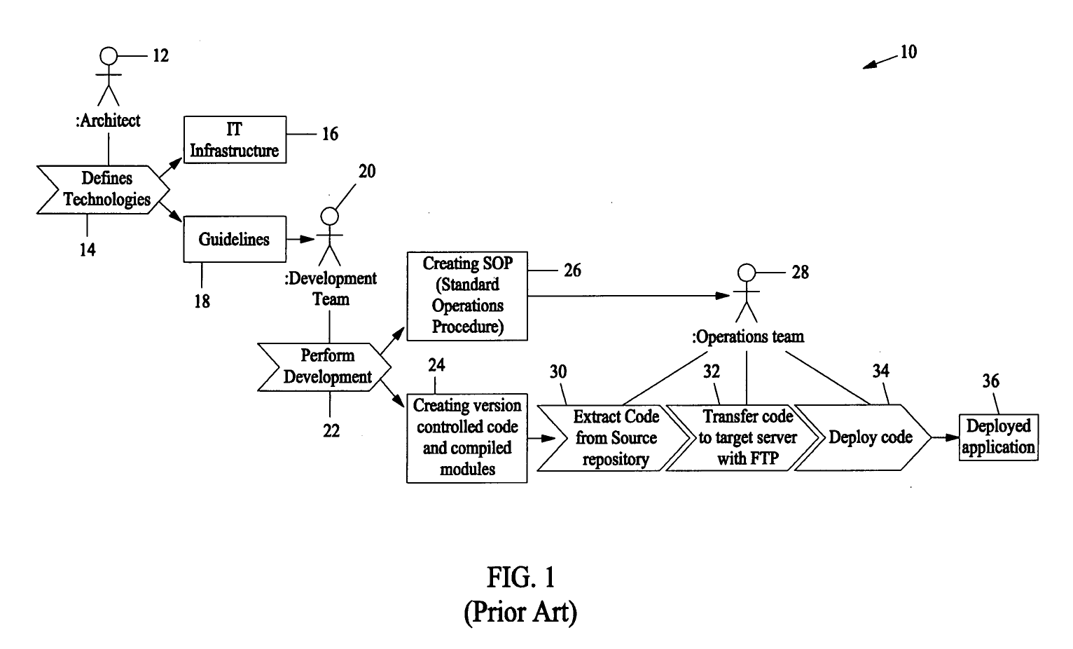

FIG. 1 is a flowchart 10 illustrating an example prior art process of deploying source code. An infrastructure architect 12 (i.e., an individual or a group performing architectural activities) defines 14 technologies to be used in an organization. The outputs of this process are IT infrastructure 16 and architectural guidelines 18. Architectural guidelines 18 are communicated 20 to development teams. The development teams perform 22 development including creating 24 product which is stored in a version control repository, and creating 26 SOP (Standard Operation Procedures) which are communicated 28 to an operations team. The operations team extracts 30 files from the version control repository, transfers 32 files to a target server with FTP (File Transfer Protocol), and deploys 34 code using SOP. This process results in a deployed 36 application.

Although this process results in a deployed application, this known process results in at least some known problems. For example, when communicating 20 architectural guidelines 18 from architect 12 to the development teams, it is difficult to attain a common understanding of guidelines 18 from the development team because such a team typically exists for only a relatively short period of time (e.g., 2-3 months) and includes mostly off-site members. Another potential problem with this known process includes misinterpretation of SOP by operations team or incompleteness/inconsistency of SOP.

During this known process, compilation is not performed during deployment, and thus, the version control repository contains compiled modules along with source code. Accordingly, the known process does not allow for traceability from source code to compiled modules. In addition, step 30 is not performed by version label and does not then verify that all files are in allowed promotion groups.

Furthermore, step 32 may lead to a high probability of error because some files will be transferred in binary mode while others are transferred in ASCII mode. Also, step 34 is performed manually and thus may result in a high probability of error. Finally, troubleshooting in the staging and production environments may be difficult within the known process because the development team does not have access to aforementioned environments and the operations team may have very limited knowledge of the application being deployed.

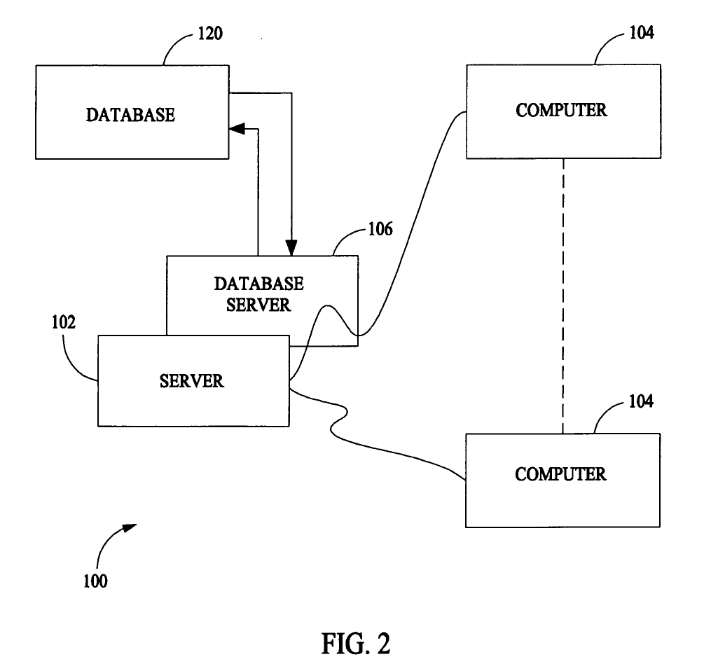

FIG. 2 is a simplified block diagram of an E-Builder System (EBS) 100 including a server system 102, and a plurality of client sub-systems, also referred to as client systems 104, connected to server system 102. In one embodiment, client systems 104 are computers including a web browser, such that server system 102 is accessible to client systems 104 via the Internet. Client systems 104 are interconnected to the Internet through many interfaces including a network, such as a local area network (LAN) or a wide area network (WAN), dial-in-connections, cable modems and special high-speed ISDN lines. Client systems 104 could be any device capable of interconnecting to the Internet including a web-based phone, personal digital assistant (PDA), or other web-based connectable equipment. A database server 106 is connected to a database 120 containing information on a variety of matters, as described below in greater detail. In one embodiment, centralized database 120 is stored on server system 102 and can be accessed by potential users at one of client systems 104 by logging onto server system 102 through one of client systems 104. In an alternative embodiment, database 120 is stored remotely from server system 102 and may be non-centralized.

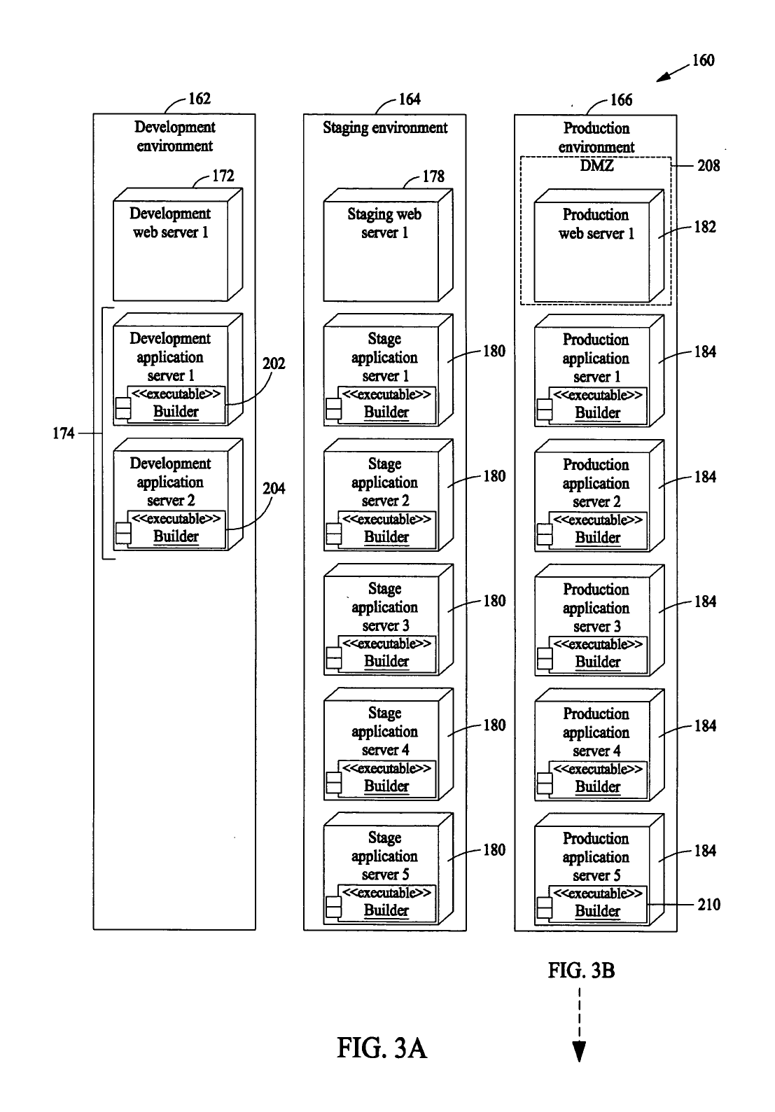

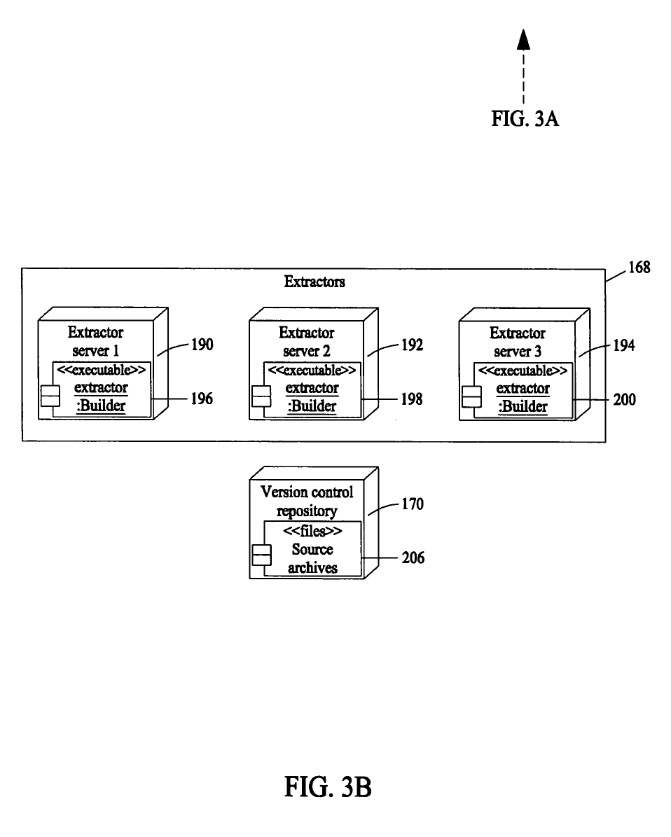

FIGS. 3A and 3B show an expanded version block diagram of an example embodiment of a server farm 160 included in EBS 100 (shown in FIG. 2). Server farm 160 includes multiple servers divided into at least the following categories: a development environment 162, a staging environment 164, a production environment 166, source extractors 168, and a version control repository 170. In the example embodiment, development servers 162 include at least one of a development web server 172, and a plurality of development application servers 174. Staging servers 164 include at least one of a stage web server 178, and a plurality of stage application servers 180. Production servers 166 include at least one of a production web server 182, and a plurality of production application servers 184.

In the example embodiment, source extractors 168 include a plurality of extractor servers 190, 192, 194, which host extractors 196, 198, 200, respectively.

Development servers 162, staging servers 164, and production servers 166 host builder instances 202, 204 which perform builds and deployments. The builders connect to extractors 196, 198, 200 to retrieve source code. A connection algorithm (not shown) selects the extractor for connection based on the load level of each extractor. In the example embodiment, the extractor having the least load level is selected for connection purposes. This approach provides load balancing and fault tolerance.

Extractor servers 190, 192, 194 host builder instances 196, 198, 200, which are also referred to as extractors. These instances are configured to perform a special kind of build. More specifically, these instances extract source code from version control repository 170 and perform additional validation and reporting steps. Version control repository 170 hosts source code archives 206 which extractors 196, 198, 200 extract code from. Production web server 182 is located in a DMZ (demilitarized zone) 208 and it is not allowed to install any extra component to this server. A builder 210 hosted by a production application server 184 deploys code to production web server 182 using scp (secured copy) method. Deployments to development web server 172 and to stage web server 178 are also performed using scp to ensure identical deployment process in all environments.

In the example embodiment, EBS 100 may be implemented generally at any operating system supporting a Java® 1.3 platform and higher.

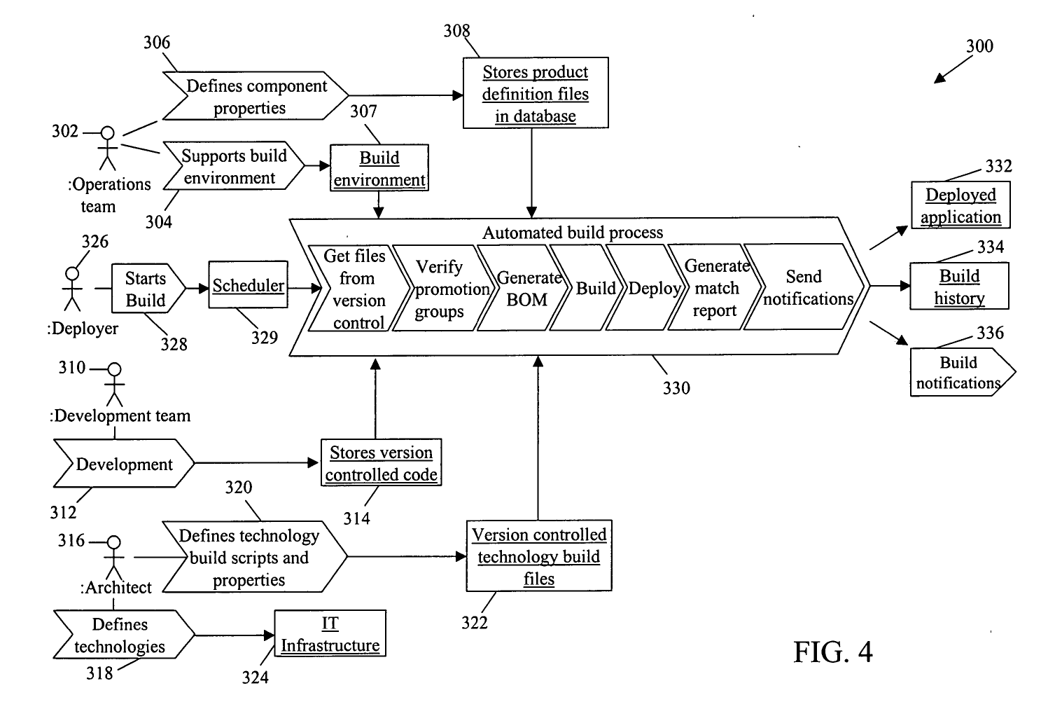

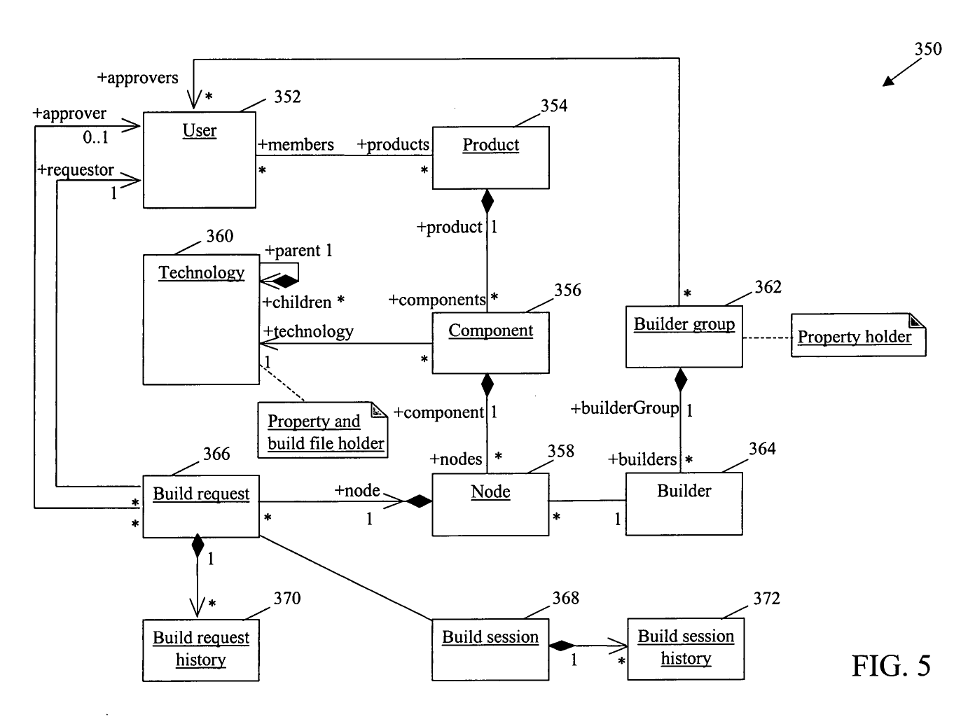

FIG. 4 is a flowchart 300 illustrating example processes utilized by EBS 100 (shown in FIG. 2) of deploying source code. The technical effect of EBS 100 is achieved when an operations team 302 supports 304 a build environment and defines 306 component build properties. A build environment 307 includes builders 202, 204 (shown in FIG. 3) and extractors 196, 198, 200 (shown in FIG. 3). Product build properties are stored 308 in database 120 (shown in FIG. 2). In the example embodiment, operations team 302 can also be referred to as an administrator. An administrator is responsible for managing the build environment including creation, deletion, and modification of instances of metamodel elements shown in FIG. 5.

A development team 310 develops 312 a project's product and stores 314 source code into version control repository 170 (shown in FIG. 3). In the example embodiment, compiled modules are not stored in version controlled repository 170. Moreover, in the example embodiment, SOP is not required. for automated deployments, and therefore, it is not shown in FIG. 4.

An architect 316 defines 318 technologies and defines 320 technology build scripts and properties. Build scripts are version controlled 322, properties can be version controlled or stored in database 120 (shown in FIG. 2). In the example embodiment, although architectural guidelines are produced, it is not critical to communicate the architectural guidelines to development team 310 because development team 310 does not define/control deployment procedures. In the example embodiment, defining 318 technologies creates an infrastructure 324. The architect is also responsible for managing the build environment, but the architect does not have permission to create or delete instances of metamodel elements included within EBS. However, the architect does have permission to modify a configuration of the instances of metamodel elements included within EBS.

A deployer 326, which is either a development team 310 member (in development environment 162 (shown in FIG. 3)) or operations team 302 member (in staging environments 164 and production environments 166 (shown in FIG. 3)), starts 328 build by invoking a builder client utility. The build request includes a particular time to execute. Deployer 326 schedules 329 the time for execution using a scheduler. The scheduler can also be used to schedule recurrent build requests, which will be executed on more than one occasion. The scheduler executes the build request by invoking automated build process 330.

Automated build process 330 extracts source code from the version control repository, verifies promotion groups, generates bill of materials (BOM), builds compiled modules, deploys application, generates change/match report, and sends notifications to deployer 326, and mailing list defined in product properties 308. The mailing list typically includes key development team 310 members. This process results in a deployed application 332, a build history 334 such as build log files, and a build notifications 336.

In the example embodiment, architectural guidelines are incorporated into build scripts. The build process fails if the guidelines are not followed. In the example embodiment, standard operation procedures (SOP) are not used for deployments; compiled modules are not stored with source code but are built in-place; and automatic build process 330 extracts files by version label and then verifies that all files are in allowed promotion groups. File type (i.e., binary/ASCII) is defined in product definition file 308. In the example embodiment, all deployment steps are automated; and build notifications 336 contain build log files, and other attachments providing development team 310 visibility to problems should they occur.

FIG. 5 is a system diagram 350 of E-Builder System (EBS) 100 (shown in FIG. 2) displaying a plurality of elements including a user 352, a product 354, a component 356, a node 358, a technology 360, a builder group 362, a builder 364, a builder request 366, and a build session 368. The elements included within system diagram 350 are also referred to as metamodel elements. Metamodel elements have instances. For example, in the example embodiment, “component” metamodel element has instance “Enterprise archive”.

In the example embodiment, user 352 is a person using EBS 100. User 352 retains information regarding system users including at least one of identification (ID), name, e-mail address, and role. A user can have multiple roles including at least one of administrator, architect, developer, deployer and approver.

Product 354 is a group of components 356 developed by the same group of developers, which together constitutes a working application. Component 356 represents a module/subsystem which can be independently built and deployed. For example, component 356 can include an application component (e.g., ear file, jar file, HTML content). Node 358 is a physical location (server/directory) where component 356 is deployed (e.g., application server for ear file or directory for HTML content). In the example embodiment, a single component 356 can be deployed to multiple nodes 358.

Technology 360 represents build files, supporting files, and properties used to build a component 356. Builder 364 includes information about a build agent that is used to deploy a component 356 to a particular node 358. Builder 364 is executable. Builder 364 accepts network requests and performs build operations.

Builder group 362 groups builders 364 by common purpose. For example, builder group 362 includes at least one of Production (PROD), Stage (STAGE), and Development (DEV) builder groups representing a promotion process wherein files are deployed to the Development builder group, then to the Stage builder group, and then to the Production builder group. In the example embodiment, the Development builder group has no limitations. The production builder group, however, includes a limitation that all build requests must be approved by an approver before they can be deployed.

In the example embodiment, the Stage builder group also includes a limitation that any given component can be deployed to the same node in the stage builder group for a limited number of times per time period. This Stage builder group limitation is also referred to as a build limit. The build limit prevents a deployer or a developer from creating more build requests per day than specified in a build limit parameter.

Build request 366 is a request to execute a build for a particular component 356 on a particular node 358. Build request 366 includes a build request history 370, which maintains historical data about build request execution. Build session 368 is an act of execution of a build request by a builder. Build session 368 includes a build session history 372, which also maintains historical data about build request execution.

In the example embodiment, EBS 100 also includes a filtering system that may be utilized when deploying source code. The technical effect of the filtering system includes protecting sensitive information (e.g., production database passwords) by not allowing deployers or developers to have access to such sensitive information. This sensitive information is therefore not stored in the version control system. In other words, for example, a developer will not place actual password values into source files, but rather, the developer places placeholders like “@db.password@” into source files for actual passwords. An administrator configures node 358 by specifying filter values and source files that shall be filtered. During the build process, builder 364 replaces placeholders (also referred to as “tokens”) with actual values.

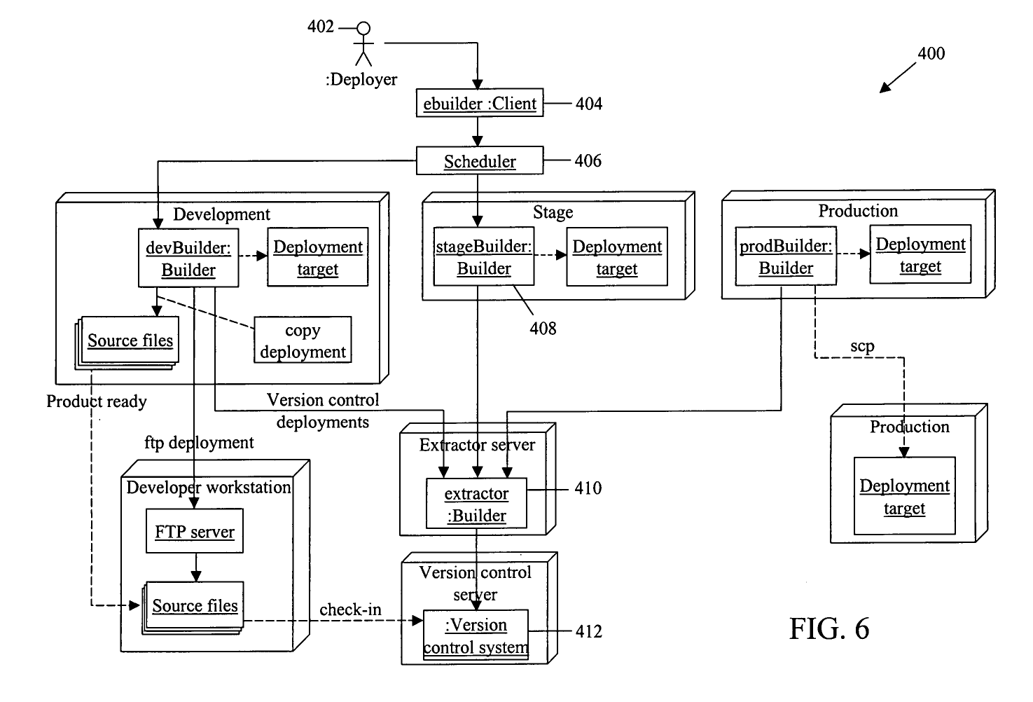

FIG. 6 is a deployment diagram 400 illustrating an example embodiment of EBS 100 (shown in FIG. 2). Deployer 402 starts a build using a client utility 404. In the example embodiment, deployer 402 provides at least one of the following parameters: (a) product name, component, node names, (b) version label, and (c) additional build parameters. Deployer 402 also schedules the build using client utility 404, which then schedules the build event within scheduler 406. When the build time arrives, scheduler 406 invokes a builder 408. Client utility 404 also confirms that a product, component, node names and a version label have been provided.

As explained above, build scheduler 406 enables a deployer 402 to schedule advanced builds. In addition, build scheduler 406 also enables a deployer 402 to schedule recurring builds. In other words, a build that recurs on a predetermined schedule can be setup using scheduler 406 such that the recurring build automatically takes place when the scheduled time arrives and scheduler 406 invokes the builder.

Builder 408 resolves an extractor 410 name using parameters communicated by deployer 402 and parameters from builder 408 configuration file. In the example embodiment, EBS 100 utilizes Java® RMI (Remote Method Invocation) over TCP/IP (Transmission Control Protocol/Internet Protocol) for network communications. Using RMI services, such as RMI over SSL (Secure Sockets Layer) and/or other security policies, allows a user to securely perform source code deployments even over public networks.

Parameters communicated by deployer 402 take precedence. Build server 408 invokes extractor 410. Build server 408 communicates parameters received from deployer 402 and parameters stored in a configuration file to extractor 410. Extractor 410 uses parameters received to resolve at least one of project and environment repository names, and version labels. Extractor 410 extracts files from a projects and environment version control repositories 412. Extractor 410 then reads project definition file extracted from projects repository and uses the information to extract project source files. Project source files are extracted based on version label provided by deployer 402. After extraction, extractor 410 asserts that revisions of files extracted are in allowed promotion groups.

Extractor 410 generates a bill of materials, which contains list of files extracted from version control repositories 412 including revision numbers and promotion group violations if any. Extractor 410 transfers extracted files and BOM (bill of materials or build of materials) to builder 408. Builder 408 resolves build properties. Builder 408 resolves build file and executes the resolved build file using resolved build properties.

In the example embodiment, Remote Method Invocation (RMI) is used for file transfer. Files are compressed before sending which allows efficient use of network bandwidth and, in concert with RMI over SSL, addresses the situation where the extractor server and the build server are in different geographic locations connected by a relatively slow public network.

In the example embodiment, builder 408 is an RMI server that performs automated builds using Ant. (Ant is a known Java based build tool that is manufactured by The Apache Software Foundation.) The build server operates as a foreground process, a background process on Unix® OS, or as a service on Windows® NT/2000/XP. (Unix is a registered trademark of American Telephone and Telegraph Company Corporation, New York, New York; and Windows is a registered trademark of Microsoft Corporation, Redmond, Wash.). Builder 408 performs at least one of the following tasks: transfers files from a client to a builder, executes Ant build files, and transfers files from a builder to a client. Ant extensions, session information, an example bill of materials, and other properties relating to EBS 100 are set forth in Appendix A.

In the example embodiment, scheduler 406 is also connected to each builder 408 and is utilized to monitor the builder. Deployer 402 (which includes a developer) uses scheduler 406 to setup a build agent monitoring schedule to determine whether a builder 408 is running and responding. If, for example, a builder 408 does not respond to a predetermined number of broadcasts from scheduler 406, an e-mail notification is transmitted to an administrator. The administrator is then notified that the particular builder 408 is not running and/or responding. The number of broadcasts and the timing for sending the broadcasts is designated using scheduler 406. Appendix B sets forth further detail relating to advanced build scheduling, recurring builds, root cause analysis for failed builds, and build agent monitoring.

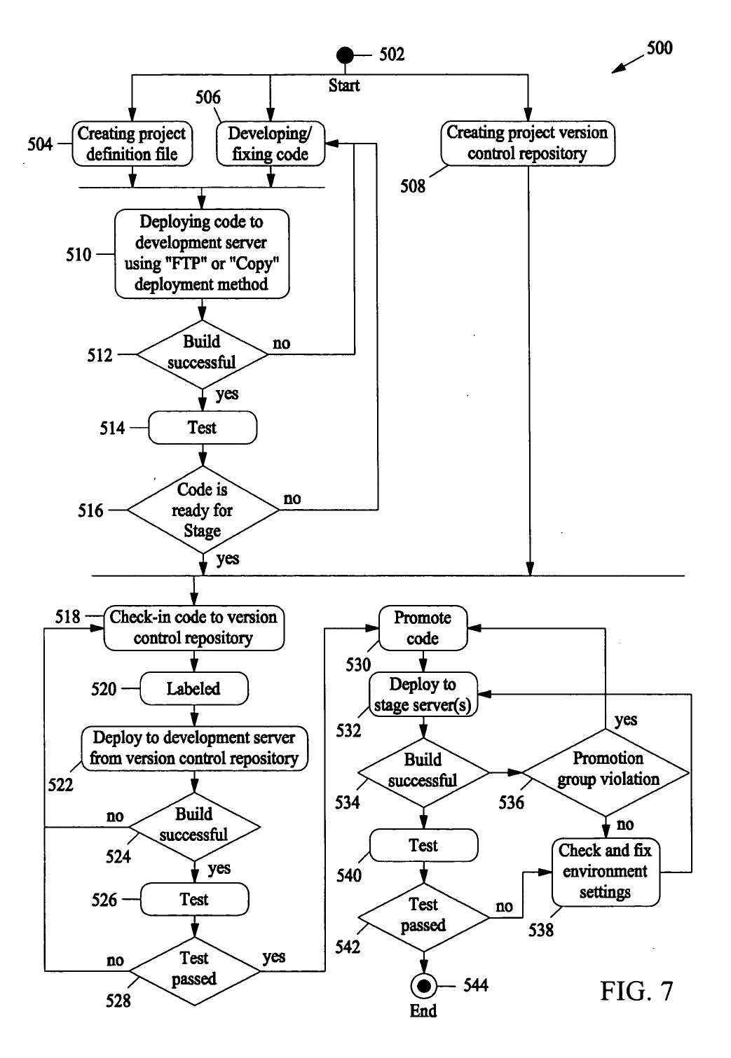

FIG. 7 is a flowchart 500 illustrating example development processes utilized by EBS 100 (shown in FIG. 2). An application (also known as a project's product) development process starts 502 with creating 504 a project definition file, developing 506 code, and creating 508 a project version control repository. Code is then deployed 510 to a development environment from a file system or a FTP server. The system then determines 512 whether the build was successful. If a build fails then the code is corrected and redeployed. Once the application is deployed successfully, the application is tested 514. After testing 514, the system determines 516 whether the code is ready for staging. Development process 506, 510, 512, 514, and 516 is repeated until the application is ready to be deployed to staging environment 164 (shown in FIG. 3).

To deploy the application to staging environment 164, the code is checked-in 518 to a version control repository and labeled 520. The application is then deployed 522 to development environment from the version control repository. The system then determines 524 whether the build was successful. A build failure means that the code was checked-in incorrectly or incompletely or improperly labeled. If a build failure occurs, steps 518 and 520 are repeated. Once the build is successful, the deployed application is tested 526. Failure to pass test 526 means that the code was checked-in incorrectly or incompletely or improperly labeled. If this occurs, steps 518-526 are repeated. Once the test is passed 528, the code is promoted 530 in the version control repository, which means it becomes eligible for deployment to staging environment 164. The application is then deployed 532 to staging environment 164.

The system then determines 534 if the build was successful. If the build fails because of a promotion group violation 536 then steps 530 and 532 are repeated. If a build failure is caused by another reason, then staging environment settings are checked 538 and corrected. Then step 532 (deploying to staging environment) is repeated. Once the application is deployed, it is tested 540. If test 540 is not passed, then steps 538 and 532 are repeated. Once test 540 is passed 542, the application is considered successfully deployed 544 to staging environment 164.

In the example embodiment, the deployment process for production environment 166 (shown in FIG. 3) is similar to the one shown herein for staging environment 164.

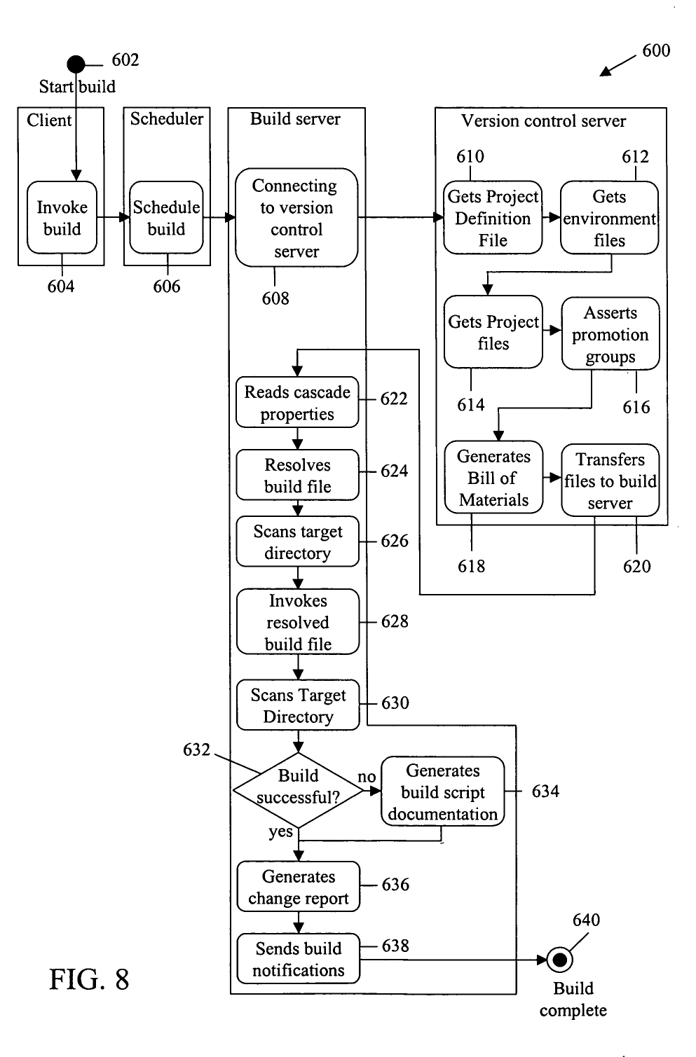

FIG. 8 is a flowchart 600 illustrating example build processes utilized by EBS 100 (shown in FIG. 2). A deployer 602 starts a build by invoking 604 a build using a client utility. Deployer 602 communicates at least one of the following parameters to the client utility: (a) project name; (b) version label; and (c) additional build parameters and properties. Deployer 602 also schedules 606 the build using the client utility and scheduler 406 (shown in FIG. 6). When the build time arrives, the client utility asserts that the project name and version label have been provided, and scheduler 406 then invokes builder 408 (shown in FIG. 6) by connecting 608 to a version control server.

Builder 408 resolves an extractor name using parameters passed by deployer 602 and parameters from build server configuration file. Parameters passed by deployer 602 take precedence. Builder 408 then invokes extractor 410 (shown in FIG. 6). Builder 408 passes the parameters from deployer 602 and configuration file to extractor 410.

Extractor 410 uses parameters received and parameters already stored to resolve project and environment repository names, and version labels. Extractor 410 extracts 610 the projects definition file from the version control system, then extracts 612 environment files from the version control system, then reads 614 the project definition file and extracts project files from the version control system, then asserts 616 that all files extracted are in allowed promotion groups, then generates 618 a bill of materials for the project files, and then transfers 620 extracted and generated files to the builder.

Builder 408 reads 622 cascade properties, resolves 624 build script, and scans 626 deployment directory and saves file information (i.e., name, date, size, and checksum). Builder 408 then invokes 628 resolved build script, and scans 630 deployment directory again. The system then determines 632 whether the build was successful. If the build fails, builder 408 generates 634 build script documentation to facilitate troubleshooting. Builder 408 then generates 636 a directory change report from two directory scans included in steps 626 and 630. Builder 408 sends 638 build notifications attaching build log files, bill of materials, change report, and build script documentation for failed builds (i.e., root cause analysis report). The build process is then completed 640.

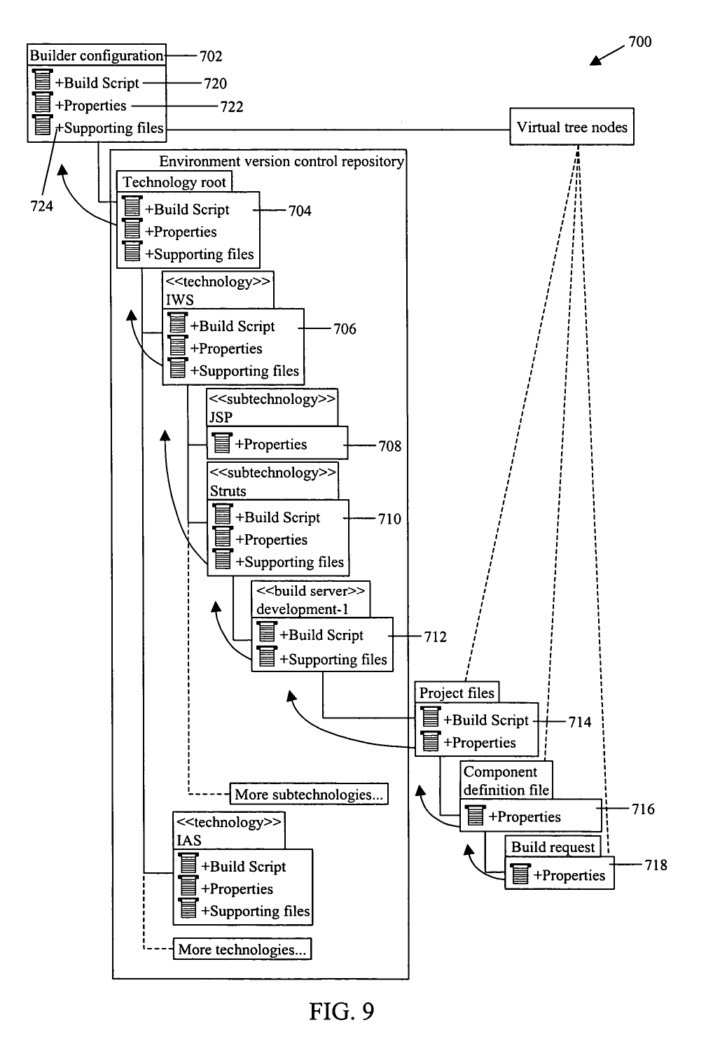

FIG. 9 is a block diagram 700 illustrating an example embodiment of a hierarchy of build sets and a property/build script resolution process for EBS 100 (shown in FIG. 2). In the example embodiment, the build process is based on a build set paradigm that includes at least one of the following build sets: a builder configuration 702, a technology root 704, a technology IWS 706, a subtechnology JSP 708, subtechnology struts 710, a build server development-1 712, projects files 714, component definition files 716, and build request 718. In one embodiment, build sets can be stored in database 120 (shown in FIG. 2) as well as in version controlled files

Builder configuration build set 702 includes a build script 720, build properties 722, and supporting files 724. Build script 720 has a predefined name build.xml. Build properties 722 are stored in a file with a predefined name build.properties. Build script 720 name is stored in a predefined property build.file.

Build request 718 is a special case of build set, which does not contain supporting files. Component definition file 716 is a special case of build set, which contains only properties. In the example embodiment, build sets are organized in a tree. Part of the tree is stored in an environment version control repository. Builder configuration 702, project files 714, component definition files 716, and build request 718 are virtually mounted to the tree for property and build script resolution purposes.

Property and build script resolution algorithm is similar in concept to Object-Oriented programming referred to as polymorphism wherein settings on lower levels of a hierarchy override settings on higher levels. In the example embodiment, property resolution is the first step in the resolution process. Property resolution starts from reading build request properties 718, then component definition files 716. If a property value is already set in build request properties 718 (e.g., build.file=ebuild.xml), then this property value is not changed and a setting of this property to some other value higher in hierarchy is ignored. The process repeats through build sets 714, 712, 710, 706, 704, and 702.

In the example embodiment, the resulting property set is used for build script resolution and for build script parameterization. The build script name is resolved in the following sequence: (1) if buildfile property is set then the value of this property is used as build script name and no further resolution is performed; (2) if project files build set 714 includes build.xml, then property buildfile is set to that file's absolute path and further processing stops; and (3) step 2 is performed up to technology root 704 in the build set hierarchy until the build script is found.

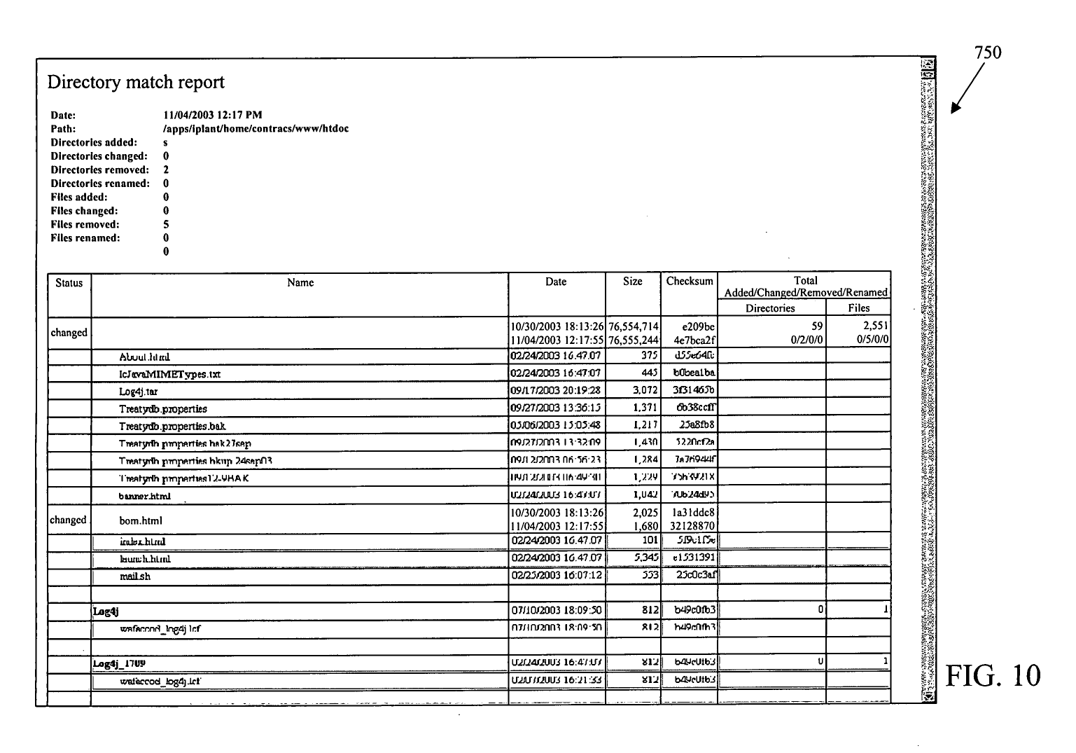

FIG. 10 is an example embodiment of a user interface 750 displaying a change report included within EBS 100 (shown in FIG. 2). In the example embodiment, the change report identifies which files have been changed during deployment. The change report includes deployed file information including at least one of a status, a file name, a date changed, a file size, and a total summary.

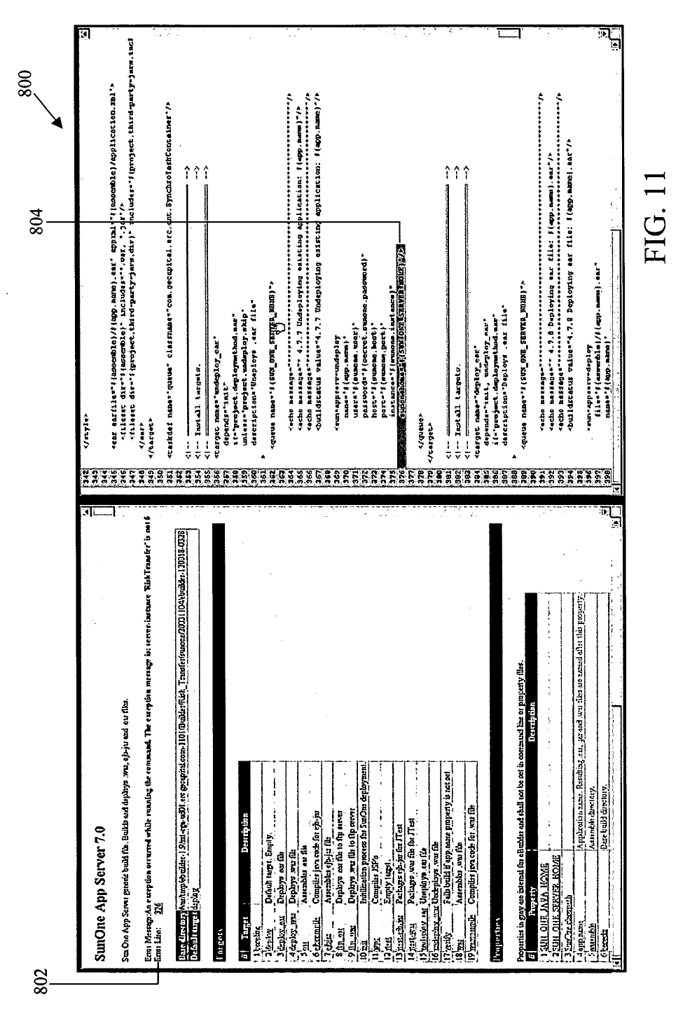

FIG. 11 is an example embodiment of a user interface 800 displaying a root cause analysis report included within EBS 100 (shown in FIG. 2). In the example embodiment, the root cause analysis report is part of the build script documentation (shown in FIG. 8). The root cause analysis report includes an error line number 802, and a highlighted error line 804 from the deployed source code. The root cause analysis report is generated after file builds are analyzed by EBS 100. The root cause analysis report indicates where a failure occurred within the file build, summarizes the most common causes of failures, and maps build script name and line number to a failure cause and recovery instructions.

The EBS therefore facilitates deployment of computer source code from a version control system to at least one of a web and application server. A technical effect of the EBS includes at least one of an automatic deployment of computer source code from a version control system to a development, a staging, and a production environment for building, compiling, packaging, and deploying files to a specific web or application server. The EBS retrieves archived source code from the version control system, performs a number of validations to determine whether the code is correct, and then deploys the code. The EBS enables a business entity to separate development and deployment processes in all environments; standardize build processes based on technology used and parameterizing these processes based on at least one of project, environment, and server; version control build files; create an isolated build environment; add pre-validation and post-validation steps to the build process; and enforce adherence with infrastructure and architectural guidelines by incorporating them into build process. The EBS also includes functionality that facilitates the automatic deployment of computer source code from the version control system to a web or application server including a build limit, a build scheduler, a build agent monitor, a filtering system, and a root cause analysis.

While the invention has been described in terms of various specific embodiments, those skilled in the art will recognize that the invention can be practiced with modification within the spirit and scope of the claims.

1. A method for deploying source code from a version control system to at least one of a web server and an application server using a build environment configured to be coupled to a client utility and a version control repository, said method comprising:
scheduling a build request using a build scheduler;
prompting a deployer to invoke the client utility including designating a specific time for execution;
extracting source code at the scheduled time from the version control repository using the build environment;
verifying promotion groups;
building compiled modules to form an application; and
deploying the application to at least one of a web server and an application server.

2. A method in accordance with claim 1 wherein scheduling a build request using a build scheduler further comprises enabling a user to schedule a computer source code build request including at least one of a one time build, a recurring build, and an advanced recurring build.

3. A method in accordance with claim 1 further comprising:
providing a build agent monitor tool in communication with the build scheduler; and
invoking the build agent monitor tool by the build scheduler to determine whether a builder is operating and responding.

4. A method in accordance with claim 3 wherein invoking the build agent monitor tool by the build scheduler further comprises connecting the build agent monitor tool to each builder on a predetermined schedule to determine whether each builder is operating and responding.

5. A method in accordance with claim 3 wherein invoking the build agent monitor tool by the build scheduler further comprises:
connecting the build agent monitor tool to each builder;
broadcasting on a predetermined schedule from the monitor tool to determine whether each builder is operating and responding; and
transmitting an electronic notification to an administrator if a builder does not respond to a predetermined number of broadcasts from the monitor tool.

6. A method in accordance with claim 1 wherein scheduling a build request using a build scheduler further comprises:
providing a build scheduler including a build limit parameter; and
limiting a number of build requests created by a deployer to the build limit parameter.

7. A method in accordance with claim 1 further comprising utilizing a filtering system to protect sensitive information including placing placeholders into source files in place of sensitive data.

8. A method in accordance with claim 7 wherein utilizing a filtering system to protect sensitive information further comprises:
specifying by an administrator filter values and source files to be filtered; and
replacing placeholders located in the source files with actual values.

9. A method in accordance with claim 1 further comprising:
providing a root cause analysis module; and
analyzing failed builds using the root cause analysis module.

10. A method in accordance with claim 9 wherein analyzing failed builds using the root cause analysis module further comprises analyzing failed builds using the root cause analysis module including summarizing the most common causes of failure, and creating a document the maps build script name and line number to a failure cause and recovery instructions.

11. A method in accordance with claim 1 further comprising connecting the client utility and the build environment via a network that includes one of a wide area network, a local area network, an intranet and the Internet.

12. A network based system for deploying source code from a version control system to at least one of a web server and an application server, said system comprising:
a build scheduler configured to prompt a deployer to designate a specific time to execute a build request;
a version control repository;
a client utility; and
a build environment configured to be coupled to said client utility and said version control repository, said build environment comprising at least one of a development environment, a staging environment, a production environment, and a plurality of extractor servers for hosting a plurality of extractors, said build environment configured to:
extract source code at the scheduled time from said version control repository;
verify promotion groups;
build compiled modules to form an application; and
deploy the application to at least one of a web server and an application server.

13. A system in accordance with claim 12 wherein said build scheduler is further configured to prompt a user to schedule a computer source code build request including at least one of a one time build, a recurring build, and an advanced recurring build.

14. A system in accordance with claim 12 further comprising a build agent monitor tool in communication with said build scheduler, said build scheduler configured to invoke said monitor tool to determine whether a builder is operating and responding.

15. A system in accordance with claim 14 wherein said build agent monitor tool is connected to each builder on a predetermined schedule to determine whether each builder is operating and responding.

16. A system in accordance with claim 14 wherein said build agent monitor tool is connected to each builder, said monitor tool configured to:
broadcast on a predetermined schedule to determine whether each builder is operating and responding; and
transmit an electronic notification to an administrator if a builder does not respond to a predetermined number of broadcasts from said monitor tool.

17. A system in accordance with claim 12 wherein said build scheduler comprises a build limit parameter, said build scheduler configured to limit a number of build requests created by a deployer to the build limit parameter.

18. A system in accordance with claim 12 further comprising a filtering system configured to protect sensitive information including placing placeholders into source files in place of sensitive data.

19. A system in accordance with claim 18 wherein said filtering system is configured to replace placeholders located in the source files with actual values after an administrator specifies filter values and source files to be filtered.

20. A system in accordance with claim 12 further comprising a root cause analysis module configured to analyze failed builds.

21. A system in accordance with claim 20 wherein said root cause analysis module is configured to summarize the most common causes of failure, create a document that maps a build script name and a line number to a failure cause and recovery instructions.

22. A system in accordance with claim 12 further comprising a communication link between said build environment and said client utility, wherein said communication link includes at least one of a wide area network, a local area network, an intranet and the Internet.

23. A system in accordance with claim 12 wherein said development environment, staging environment, and production environment host builders which perform source code builds and deployments, said builders in communication with said plurality of extractors for retrieving source code.

24. A system in accordance with claim 23 wherein said build environment is further configured to:
create a project definition file;
develop source code;
create a project version control repository; and
deploy the source code to said development environment from a file system.

25. A system in accordance with claim 24 wherein said build environment is further configured to:
determine whether the source code build at said development environment was successful;
promote the source code in the version control repository; and
deploy the source code from said development environment to said staging environment.

26. A system in accordance with claim 25 wherein said build environment is further configured to:
determine whether the source code build at said staging environment was successful;
promote the source code in the version control repository; and
deploy the source code from said staging environment to said production environment.

27. A system in accordance with claim 12 wherein said development environment comprises at least one of a development web server and a plurality of development application servers.

28. A system in accordance with claim 12 wherein said staging environment comprises at least one of a stage web server and a plurality of stage application servers.

29. A system in accordance with claim 12 wherein said production environment comprises at least one of a production web server and a plurality of production application servers.

30. A system in accordance with claim 12 wherein said build environment is further configured to:
develop an application and store source code in said version control repository; and
define technologies and technology build scripts and properties.

31. A computer program embodied on a computer readable medium for deploying source code from a version control system to at least one of a web server and an application server, said program comprising at least one code segment that:
prompts a deployer to designate a specific time to execute a build request using a build scheduler;
prompts a deployer to invoke a client utility;
extracts source code at the scheduled time from the version control repository using a build environment, the build environment is configured to be coupled to the client utility and the version control repository;
verifies promotion groups;
builds compiled modules to form an application; and
deploys the application to at least one of a web server and an application server.

32. A computer program in accordance with claim 31 further comprising a code segment that:
prompts a user to schedule using the build scheduler a computer source code build request including at least one of a one time build, a recurring build, and an advanced recurring build.

33. A computer program in accordance with claim 31 further comprising a code segment that:
enables a build agent monitor tool to communicate with the build scheduler; and
enables the build agent monitor tool to determine whether a builder is operating and responding.

34. A computer program in accordance with claim 33 further comprising a code segment that:
connects the build agent monitor tool to each builder on a predetermined schedule; and
determines whether each builder is operating and responding.

35. A computer program in accordance with claim 33 further comprising a code segment that:
connects the build agent monitor tool to each builder;
enables the monitor tool to broadcast on a predetermined schedule to each builder;
determines whether each builder is operating and responding; and
transmits an electronic notification to an administrator if a builder does not respond to a predetermined number of broadcasts from the monitor tool.

36. A computer program in accordance with claim 31 further comprising a code segment that:
recognizes a build limit parameter included within the build scheduler; and
limits a number of build requests created by a deployer to the build limit parameter.

37. A computer program in accordance with claim 31 further comprising a code segment that:
provides a filtering system; and
utilizes the filtering system to protect sensitive information by placing placeholders into source files in place of sensitive data.

38. A computer program in accordance with claim 37 further comprising a code segment that:
enables an administrator to specify filter values and source files to be filtered; and
replaces placeholders located in the source files with actual values.

39. A computer program in accordance with claim 31 further comprising a code segment that:
provides a root cause analysis module; and
analyzes failed builds using the root cause analysis module.

40. A computer program in accordance with claim 39 further comprising a code segment that:
analyzes failed builds using the root cause analysis module;
summarizes the most common causes of failure; and
creates a document that maps a build script name and a line number to a failure cause and recovery instructions.
